(19) United States
(12) Patent Application Publication
(10) Pub. No.: US 2010/0025982 A1
(43) Pub. Date: Feb. 4, 2010

(54) COUPLING, JOINT AND METHOD FOR FIXEDLY AND SEALINGLY SECURING COMPONENTS TO ONE ANOTHER

(75) Inventor: Tommy L. Jamison, Hernando, MS (US)

Correspondence Address: HARNESS, DICKEY & PIERCE, P.L.C., P.O. BOX 828, BLOOMFIELD HILLS, MI, 48303, US

(73) Assignee: Mueller Industries, Inc., Memphis, TN (US)

(21) Appl. No.: 12/183,761

(22) Filed: Jul. 31, 2008

(51) Int. Cl. F16L 21/00

(52) U.S. Cl. 285/31

(57) ABSTRACT

A method for forming a joint. The method includes: providing a fitting having a body and a pair of axially spaced apart seals, the body having an insertion end; providing a structure; engaging the fitting and the structure to one another such that the seals sealing engage the body and the structure; and after the fitting and the structure have been engaged to one another, installing an adhesive to a zone disposed between the body, the structure and the seals to retain the body to the structure. A fitting and an assembly are also provided.

The present invention generally relates to a coupling, joint and method for fixedly and sealingly securing components to one another.

There has long been a need for joining two components in a manner that fixedly and sealingly couples the components to one another. One extremely common application concerns the coupling of copper tubing that is commonly employed to transmit potable water in a building.

Sweat soldering has long been used for the connection of components of copper based supply and distribution systems for potable water, especially in single family residential constructions, due to its durability and the relative ease with which lead-based solder connections could be made. Modern plumbing codes have mandated lead-free solders and water soluble fluxes and as such, the difficulty in making sweat solder connections has significantly increased, particularly where relatively large diameter copper tubing is utilized. More particularly, the lead-free solders and water soluble fluxes tend to be less tolerant of certain variables (e.g., the presence of oxidation and/or the use of excessive heat) than the lead-based solders and acid-based fluxes. Furthermore, sweat soldering can be relatively time consuming.

In an effort to eliminate the disadvantages of sweat solder connections, it was proposed that a two-part epoxy be employed to adhesively couple the tubing and connectors to one another. More specifically, it is known to apply a two-part epoxy adhesive between a copper tube and a copper fitting (the copper fitting being suitable for coupling to the copper tube via traditional sweat soldering). Such epoxies have performed well in fixedly coupling components to one another but have not performed well in forming a seal between the components. Our analyses reveal a failure mode wherein the sliding of the fitting onto the tubing (or the tubing into the fitting) has the effect of scraping the epoxy off relatively small portions of the tubing and/or the fitting so that a void was formed therebetween. While the epoxy generally has sufficient strength to couple the fitting and the tubing together, the presence of the void rendered the joint unsuitable for its intended function (e.g., to communicate a fluid, such as potable water or a refrigerant therethrough without leaking).

Another connection process that has been proposed employs fittings that utilize internal seals wherein the fittings are crimped directly to lengths or sticks of conventional hard drawn copper tubing. The Profipress system that is marketed by Viega GmbH & Co. KG of Attendorn, Germany, for example, includes an inner o-ring seal that is carried on an inner diameter of the fitting and which sealingly engages the copper tubing upon insertion into the fitting. A crimping tool is subsequently employed to crimp the fitting to the tubing to thereby fixedly couple the tubing and the fitting to one another. This system, however, is known to suffer from several drawbacks.

One such drawback concerns the sealing of the fitting to an outside surface of the copper tubing. It is well known in the art that the outside surface of a copper tube is relatively susceptible to imperfections (e.g., gouges, scratches and the like) during its formation via extrusion as well as to damage during shipping and storage. As such imperfections and damage may adversely affect the ability of the fittings to seal against the outer surface of the tubing, manufacturers of the copper tubing typically subject the extruded sticks of tubing to an eddy current test to verify the integrity of each stick's outside surface. This testing is costly and as we have found, leaks are possible even when the tubing conforms to published standards. Accordingly, it appears that a relatively time consuming manual inspection must be made of each tube prior to its coupling to a fitting.

Another drawback concerns the incompatibility of the known systems with lengths of annealed copper tubing. In this regard, the annealed copper tubing is readily deformable and thus the crimping process fails to secure the fitting and the annealed copper tubing together. Accordingly, plumbing contractors must equip themselves with two discrete sets of fittings: one set of crimp fittings that are compatible with the hard drawn sticks of tubing and another set of fittings (e.g., flare or compression fittings) that are compatible with the annealed coils of tubing.

Yet another drawback concerns the cost of the crimp-type fittings and the tooling for installing the crimp-type fittings. More specifically, the fittings are relatively heavy and can weigh 25% or more than a correspondingly sized sweat solder fitting. As copper is relatively expensive, the manufacture and use of these fittings can be disadvantageous from a cost perspective. Moreover, the tooling for installing (i.e., crimping) the fittings tends to be relatively expensive. As such, it can be relatively costly to equip a crew so that it will have the capability to install such fittings.

A further drawback concerns the joining of conduits in relatively high pressure applications, such as cooling or refrigerant systems that utilize the new high pressure refrigerants such as R410A and others. More specifically, the known crimp-type fittings appear to be incapable of use in relatively high pressure applications as the fitting tends to separate from the tube when subjected to elevated fluid pressures. Soldering or brazing can also be undesirable in high pressure applications where the fluid conduit is hard drawn (i.e., work hardened). The application of heat to facilitate the soldering or brazing operation can anneal the conduit and thereby significantly lower its tensile strength.

In view of the aforementioned disadvantages with the known connection systems, there remains a need in the art for a connection system that can be used to fixedly and sealingly couple components together that is both reliable and relatively inexpensive.

### SUMMARY

This section provides a general summary of some aspects of the present disclosure and is not a comprehensive listing or detailing of either the full scope of the disclosure or all of the features described therein.

In one form, the present teachings provide a method for forming a joint. The method includes: providing a fitting having a body and a pair of axially spaced apart seals, the body having an insertion end; providing a structure; engaging the fitting and the structure to one another such that the seals sealing engage the body and the structure; and after the fitting and the structure have been engaged to one another, installing an adhesive to a zone disposed between the body, the structure and the seals to retain the body to the structure.

In another form, the present teachings provide fitting that includes a body, a first seal and a second seal. The body has an insertion end with an end face. The body defines a cavity with a first mount, a second mount a fill aperture and a vent aperture. The second mount is spaced axially apart from the first mount. The first seal is received in the first mount and the second seal is received in the second mount. The fill aperture and the vent aperture extend radially through the body and wherein the fill aperture and the vent aperture are disposed between the first and second seals.

Further areas of applicability will become apparent from the description provided herein. It should be understood that the description and specific examples in this summary are intended for purposes of illustration only and are not intended to limit the scope of the present disclosure, its application and/or uses in any way.

### BRIEF DESCRIPTION OF THE DRAWINGS

The drawings described herein are for illustrative purposes only and are not intended to limit the scope of the present disclosure in any way. The drawings are illustrative of selected teachings of the present disclosure and do not illustrate all possible implementations. Similar or identical elements are given consistent identifying numerals throughout the various figures.

FIG. 1 is a schematic illustration of an assembly constructed in accordance with the teachings of the present disclosure;

FIG. 2 is a side elevation view of a portion of the assembly of FIG. 1 illustrating an exemplary joint that includes a pair of tubular structures, a fitting and an adhesive;

FIG. 3 is a longitudinal section view of a portion of the assembly of FIG. 1, illustrating the exemplary joint at a time before the adhesive is employed to fixedly couple the tubular structures and the fitting to one another;

FIG. 4 is a longitudinal section view of the fitting;

FIG. 5 is a sectional view of a portion of an alternatively constructed fitting taken perpendicular to the longitudinal axis of the fitting and through the apertures in the body;

FIG. 6 is a longitudinal sectional view of a portion of another alternatively constructed fitting;

FIGS. 7 through 9 are partial sectional views illustrating the introduction of the adhesive to the fitting;

FIG. 10 is an exploded perspective view of a portion of an alternately constructed joint in which a structural member has been modified to include a locking element;

FIGS. 11 and 12 are perspective views of structures with alternately constructed locking members;

FIG. 13 is a longitudinal section view of a joint that employs the structure of FIG. 12;

FIG. 14 is a side elevation view of an exemplary tool employed for forming the locking member illustrated in FIG. 12;

FIG. 15 is a top view of a portion of the tool of FIG. 14 illustrating the knurling wheels in more detail; and

FIG. 16 is a longitudinal section view of a portion of another assembly constructed in accordance with the teachings of the present disclosure.

### DETAILED DESCRIPTION OF THE VARIOUS EMBODIMENTS

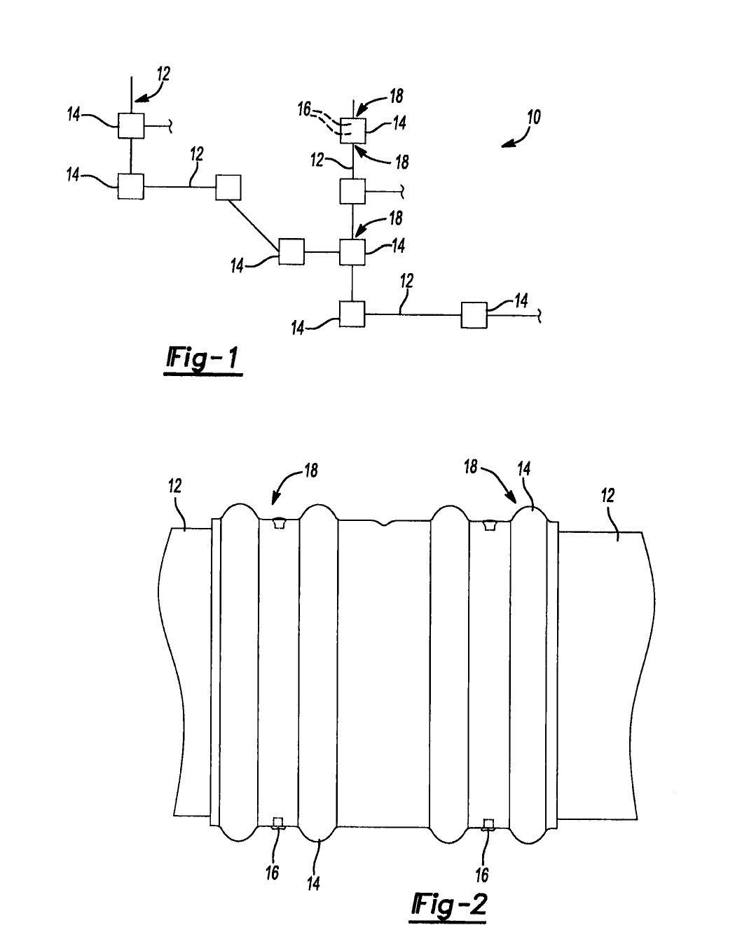

With reference to FIG. 1 of the drawings, an assembly constructed in accordance with the teachings of the present invention is schematically illustrated and is generally indicated by reference numeral 10. With additional reference to FIG. 2, the assembly 10 can include a component or structure 12, a fitting 14, and an adhesive 16 that can cooperate to form a joint 18. In the particular example illustrated, the assembly 10 is suited for use in communicating (i.e., supplying, delivering, routing) a fluid, such as a gas or liquid and as such, the structure 12 is illustrated to be a length of tubing. More particularly, the structure 12 in the particular embodiment illustrated is a length of drawn (full hard) copper tubing that is suitable for use in a system for the transmission of potable water. It will be appreciated, however, that the teachings of the present invention have broader applicability and as such, the scope of the present disclosure (and appended claims) is not limited to the particular application of the invention described and illustrated herein but rather extends to any joint wherein the components of the joint are fixedly or fixedly and sealingly joined by an adhesive in the manner disclosed herein. In this regard, it will be appreciated that the structure 12 need not be a tubular structure but rather could be any structure, such as a shaft, that sufficiently corresponds in size and shape to the fitting 14 so that the adhesive 16 may cooperate with the two to form a connection or joint 18.

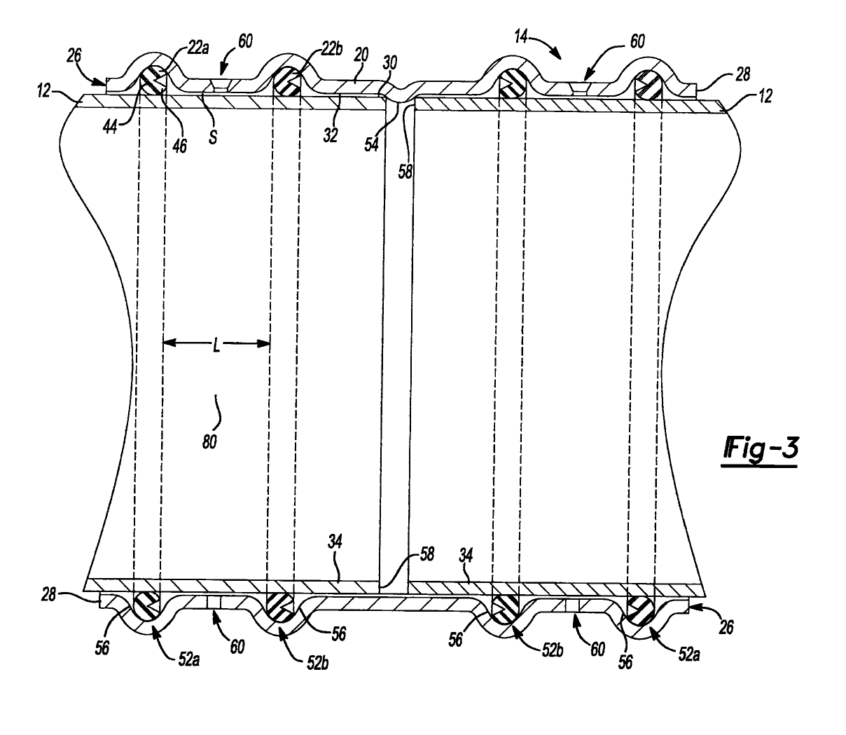

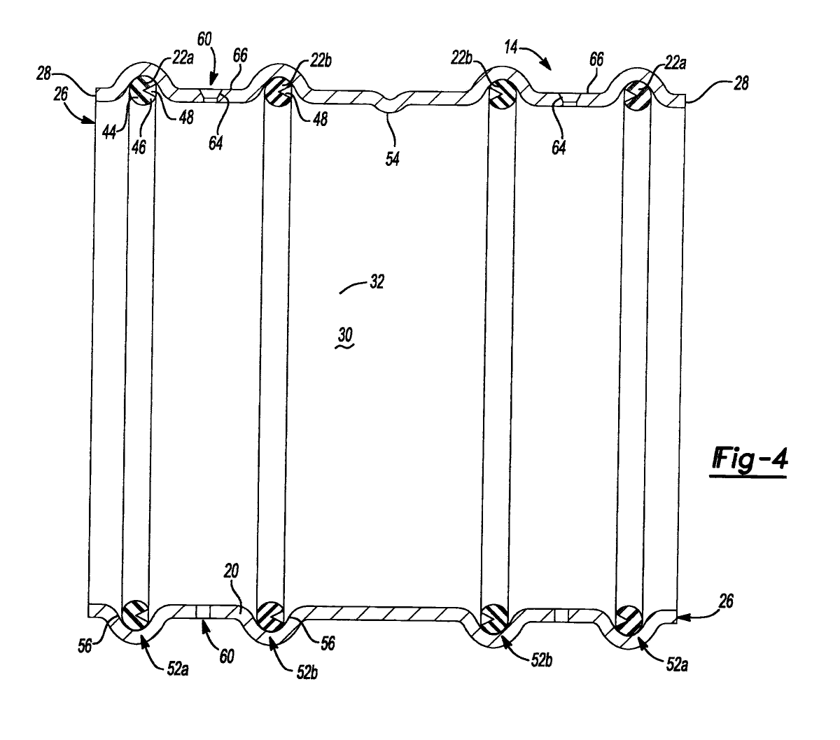

With reference to FIGS. 2 and 3, the fitting 14 can include a body 20 and a pair of sealing elements 22a and 22b. It will be appreciated that although the particular fitting illustrated is a straight union, the teachings of the present invention have applicability to various other types of fittings, including elbows, tees, caps, adapters, reducers, bushings, etc.

The body 20 can be made from any structural material, such as plastic, copper, brass, bronze, stainless steel or another metal. In the example provided, the body 20 is made of a copper alloy so as to eliminate the potential for a galvanic reaction with the copper alloy of the structure 12. The body 20 can include an insertion end 26 that can define an end face 28 and a cavity 30 having an interior surface 32. The cavity 30 can be configured to receive an associated end 34 of the structure 12.

The sealing elements 22a and 22b can be sized to support and the associated end 34 of the structure 12 within the cavity 30 and sealingly engage both the body 20 and the exterior surface 40 of the associated end 34 of the structure so that the exterior surface 40 is spaced apart from the interior surface 32 of the cavity 30 to form a space S therebetween. In the particular example provided, the sealing elements 22a and 22b are engineered lip seals having a body 44 and a lip member 46 that cooperate to form an annular seal cavity 48. As the example provided relates to a system for communicating a fluid, the sealing elements 22a and 22b are configured to sealingly engage the interior surface 32 and the exterior surface 40. Those of skill in the art will appreciate from this disclosure that other types of seals, including O-rings, could be used and that in situations where the formation of a seal is unnecessary, one or both of the sealing elements 22a and 22b could be formed of a material that does not form a seal against one or both of the interior surface 32 and the exterior surface 40.

The body 20 can include a pair of mounts 52a and 52b and a stop 54. Each of the mounts 52a and 52b can be spaced axially apart from one another and can be configured to hold and position an associated one of the sealing elements 22a and 22b, respectively. In the particular example provided, the mounts 52a and 52b have a flattened U-shape with a root 52r that is sized to engage a corresponding one of the sealing elements 22a and 22b and leg portions 52s that are coupled to and diverge outwardly from the root 52r so that they do not contact the sealing elements 22a and 22b. The stop 54 can be a feature that can inhibit the insertion of the structure 12 into the cavity 30 beyond a predetermined distance. In the particular example provided, the mounts 52a and 52b are annular U-shaped grooves 56 that are spaced apart to receive an associated one of the sealing elements 22a and 22b therebetween, while the stop 54 comprises a dimple that is formed in the body 20 inwardly from the insertion end 26, past the sealing elements 22a and 22b. The dimple can extend radially inwardly into the cavity 30 to an extent where it will contact the end face 58 of the structure 12 to inhibit further insertion of the structure 12 into the cavity 30. The mounts 52a and 52b and the stop 54 are elements that are well known in the art and as such, a detailed discussion of their configuration and/or operation is not needed herein.

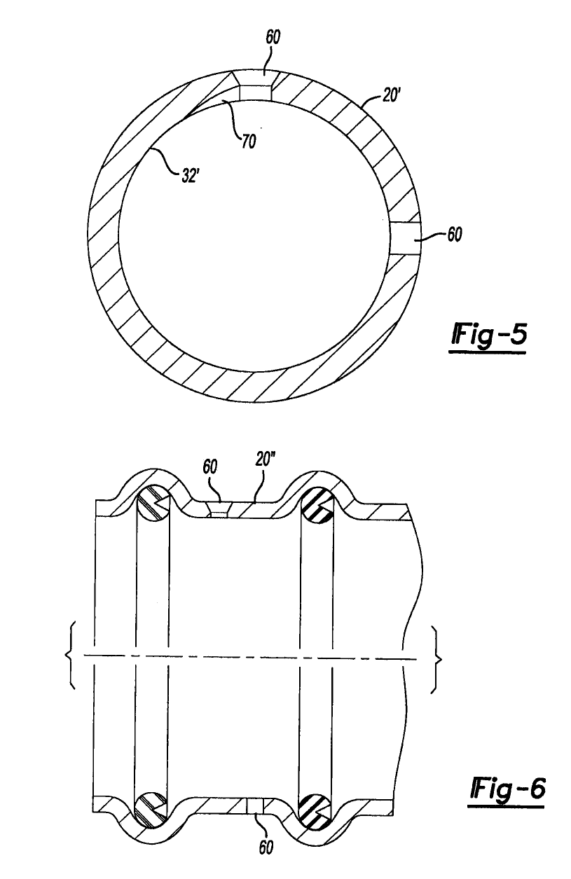

The body 20 can also define two or more apertures 60 that can be positioned between the sealing elements 22a and 22b and which can extend into the cavity 30. The apertures 60 can be formed in any desired process, such as drilling or punching. If the apertures 60 are formed via punching, for example, the interior surface 32 of the body 20 can be rolled after the apertures 60 are punched and while the mounts 52a and 52b are formed to remove any burr that may extend from the interior surface 32. If the apertures 60 are formed in a drilling operation, a center drill (not shown) or similar tool bit can be employed in the drilling operation such that a chamfer or countersink 64 is formed on the outer surface 66 of the body 20. The countersink 64 can be formed with a predetermined interior angle, such as an interior angle of about 60 degrees. In the particular example illustrated, one of the apertures 60 is punched and the other one of the apertures 60 is formed with a center drill in a drilling operation for purposes of illustration only. Also in the particular example illustrated, only two of the apertures 60 are provided between each set of sealing elements 22a and 22b and the apertures 60 are disposed at the same distance from the end face 28 but spaced circumferentially 180 degrees apart from one another. It will be appreciated, however, that the apertures 60 can be disposed at any desired circumferential and/or axial position. In the example of FIG. 5, the body 20′ is configured such that the apertures 60 are spaced circumferentially apart from one another by an angle of 90 degrees. In this example, a flow directing feature 70 is formed onto or couple to the interior surface 32 to aid in directing the adhesive 16 (FIG. 1) in a predetermined direction (i.e., counter-clockwise in the example provided). In the example of FIG. 6, the body 20″ is configured such that the apertures 60 are axially spaced apart from one another.

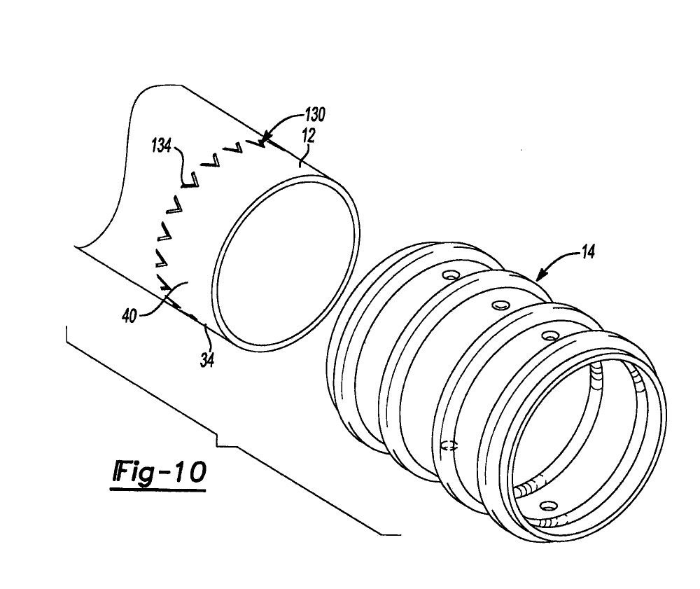

With reference to FIG. 9, the adhesive 16 can be any appropriate adhesive for bonding the structure 12 and the body 20 to one another. In the particular example provided, the adhesive 16 is a two-part epoxy, such as the DP460 Scotch-Weld™ epoxy adhesive that is marketed by Minnesota Mining and Manufacturing, Inc. of St. Paul, Minn., but it has been found that other adhesives, including the DP100 Plus Scotch-Weld™ epoxy adhesive and the DP-810NS Scotch-Weld™ acrylic adhesive that are marketed by Minnesota Mining and Manufacturing, Inc. of St. Paul, Minn. are also well suited for the exemplary assembly 10 described and illustrated herein. Those of ordinary skill in the art will appreciate that numerous considerations factor into the selection of a particular adhesive, including the shear strength of the adhesive, the peel strength of the adhesive, the viscosity of the adhesive, the worklife of the adhesive, the cure time of the adhesive, the cost of the adhesive, the chemical reactivity of the adhesive, the material compositions of the structure 12 and the fitting 14, the amount of clearance between the exterior surface 40 of the structure 12 and the interior surface 32 of the body 20, the working temperature of the assembly, and the amount of vibration (i.e., amplitude and frequency) that is transmitted through the assembly. Accordingly, it will be appreciated that the adhesive 16 is not limited to the particular adhesives that are specifically disclosed herein or to epoxy adhesives and/or acrylic adhesives generally.

With specific reference to FIG. 3, the sealing elements 22a and 22b can be spaced axially apart from one another define a coupling zone 80 therebetween having a length L. The length L of the coupling zone 80 can be selected to provide sufficient area so that the adhesive 16 (FIG. 9) will be sufficiently strong to fixedly couple the structure 12 and the body 20 to one another so that the joint 18 (FIG. 9) can be subjected to a predetermined (maximum) pressure without failure of the joint 18 (FIG. 9). As the adhesive 16 (FIG. 9) is disposed between the sealing elements 22a and 22b, a first one of the sealing elements 22a can be positioned relatively close to the end face 28 of the body 20.

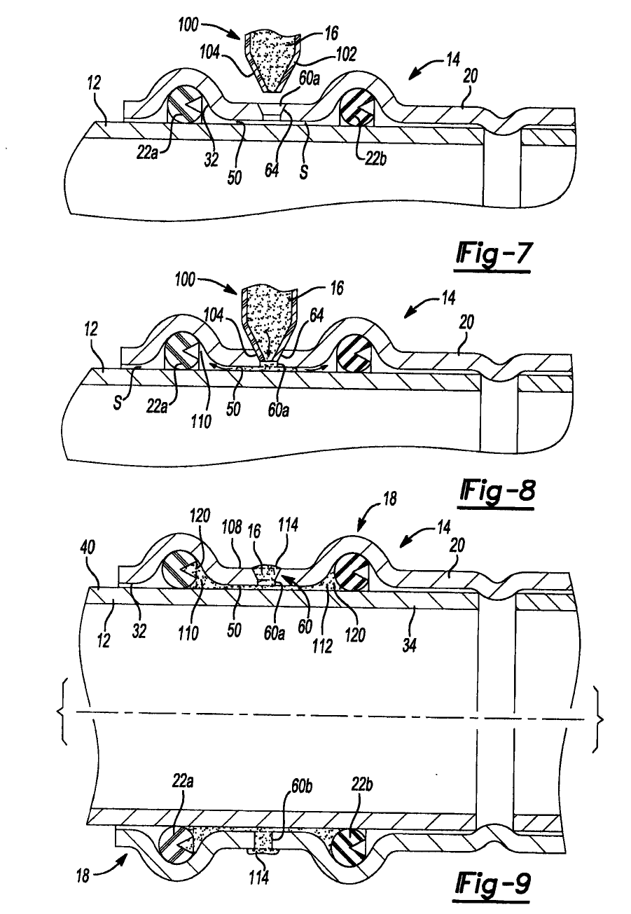

With reference to FIGS. 7 through 9, the fitting 14 can be dry fitted to the structure 12 such that the sealing elements 22a and 22b can be sealingly engaged to the interior surface 32 of the body 20 and the exterior surface 40 of the associated end 34 of the structure 12. Depending upon the type of material or materials used for the body 20 and the structure 12, it may be desirable or necessary to clean the interior surface 32 and/or the exterior surface 40. In the particular example provided, the interior surface 32 of the body 20 was not cleaned, but the exterior surface 30 of the structure 12 was cleaned by initially sanding the exterior surface 30 with sandpaper of an appropriate grit (e.g., 120 grit) and thereafter applying an alcohol solvent to the surface 30. The dry friction between the structure 12 and the fitting 14 can be tailored to a desired level by selection of the type of seals employed for the sealing elements 22a and 22b and their geometry. In the particular example provided, the dry friction between the structure 12 and the fitting 14 is relatively high so that it would not be necessary to prop up vertically oriented portions of the assembly 10 (FIG. 1), if any, while the adhesive 16 in the coupling zone 50 cures, even when the structure 12 is relatively large and heavy (e.g., a metal tube or pipe having a nominal diametrical dimension that is greater than or equal to two inches). In the example provided, the surface contact obtained with the engineered lip seals is 60% greater than the surface contact with conventional O-ring seals. As it is possible to dry-fit the assembly 10 (FIG. 1), in whole or in part as desired, cure times for the adhesive 16 can be relatively low. It will be appreciated, however, that the adhesive 16 could be selected from adhesives having broadly different cure times (e.g., from 20 minutes or less to more than 8 hours) to meet the needs of a given situation.

An applicator 100 with a nozzle 102 can be employed to introduce the adhesive 16 into the coupling zone 50. The applicator 100 can include a means for dispensing the adhesive 16 (e.g., a pump), which can be operated in any desired manner, including manually, pneumatically and/or electrically. Suitable applicators are available commercially from several sources, such as the Scotch-Weld EPX Plus II applicator marketed by the Minnesota Mining and Manufacturing, Inc. of St. Paul, Minn. In the particular example provided, the one of the apertures 60 with the countersink 64 is employed to directly receive the adhesive 16 (this aperture 60 will be referred to hereinafter as “the fill aperture 60a”) and the nozzle 102 includes a frusto-conical tip 104 having an included angle that matches the included angle of the countersink 64. Construction in this manner can help to align the nozzle 102 to the fill aperture 60a, while mating engagement between the tip 104 and the countersink 64 can aid in preventing adhesive from being dispensed over the outer surface 108 of the body 20. It will be appreciated however, that either one of the apertures 60 could be employed to directly receive the adhesive 16.

The adhesive 16 can be dispensed (e.g., pumped) through the nozzle 102 and the fitting 14 into the space S between the body 20 and the structure 12. We have found that the adhesive 16 will flow longitudinally toward the sealing elements 22a and 22b and will flow in a first annular channel 110 between the sealing member 22a and the mount 52a and in a second annular channel 112 between the sealing member 22b and the mount 52b. The adhesive 16 will flow out of the other aperture 60 (hereinafter referred to as “the vent aperture 60b”) when the coupling zone 50 has been filled with the adhesive 16. The sealing elements 22a and 22b confine the adhesive 16 in the coupling zone 50 and as such, the adhesive 16 is not disposed in a portion of the cavity 30 in the body 20 that is in fluid communication with the interior of the structure 12 in the example provided. Moreover, as the coupling zone 50 has a predetermined volume, it is possible to meter a given volume of the adhesive 16 into the coupling zone 50 to ensure that a desired amount of the adhesive 16 is disposed within the joint 18 and to conserve the adhesive 16. Adhesive material 114 extending from the apertures 60 can be employed as a means of verifying that the joint 18 has been properly assembled.

Those of skill in the art will appreciate that the coupling zone 50 could be entirely filled with the adhesive 16 when the adhesive 16 begins to flow out of the vent aperture 60b, or that the coupling zone 50 could be partially filled with the adhesive 16 (i.e., there could be one or more voids in the adhesive 16 located in the coupling zone 50). In our experience, however, voids are not typically formed in the coupling zone 50.

As the seal between the structure 12 and the body 20 of the fitting 14 is formed by the sealing elements 22a and 22b rather than the adhesive 16, the presence of one or more voids (not shown) in the adhesive 16 located within the coupling zone 50 will not affect the sealing capacity of the fitting 14. Moreover, the adhesive need not bond to both the structure 12 and the body 20. In the example provided, the exterior surface 40 of the associated end 34 of the structure 12 was cleaned prior to assembly of the fitting 14 to the structure 12 and consequently, the adhesive 16 is well bonded to the exterior surface 40. After curing, the adhesive 16 is structural and can have a flattened, generally U-shape that defines a pair of annular projections 120 that extend into the channels 110 and 12, respectively. The annular projections 120 can inhibit axial movement of the fitting 14 relative to the structure 12.

As the task of sealing (which can be performed by the sealing elements 22a and 22b) is separate from the task of fixedly coupling the body 20 to the structure 12 (which can be performed by the adhesive 16 in the coupling zone 50), the body 20 and the structure 12 can be formed of different materials (e.g., CPVC, PVC, or stainless steel can be employed for the body 20, while copper can be employed for the structure 12). Through selection of the adhesive and/or treatment of the body 20, the adhesive 16 need not bond to the body 20 so that the sealing elements 22a and 22b can move depending on the differences in thermal expansion of the body 20 relative to the structure 12.

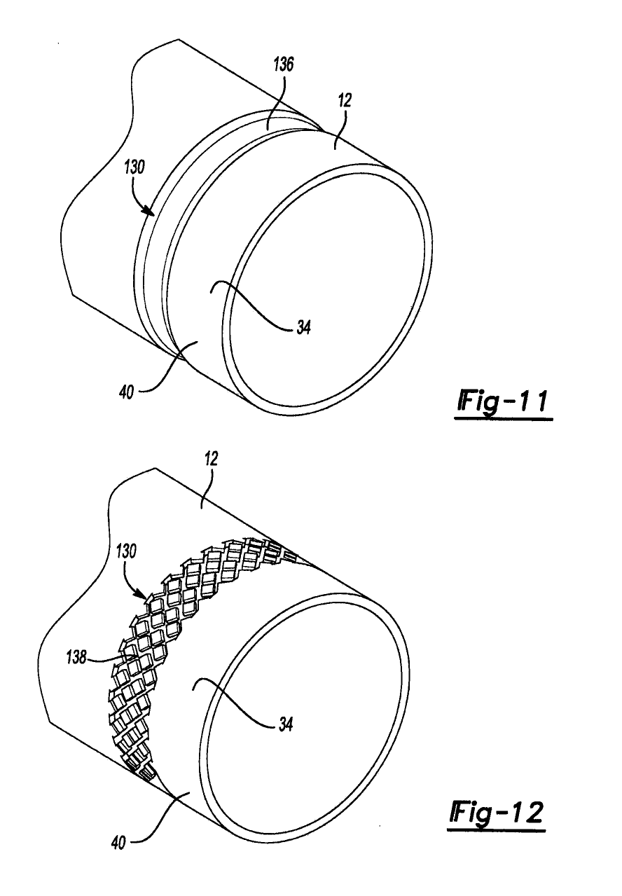

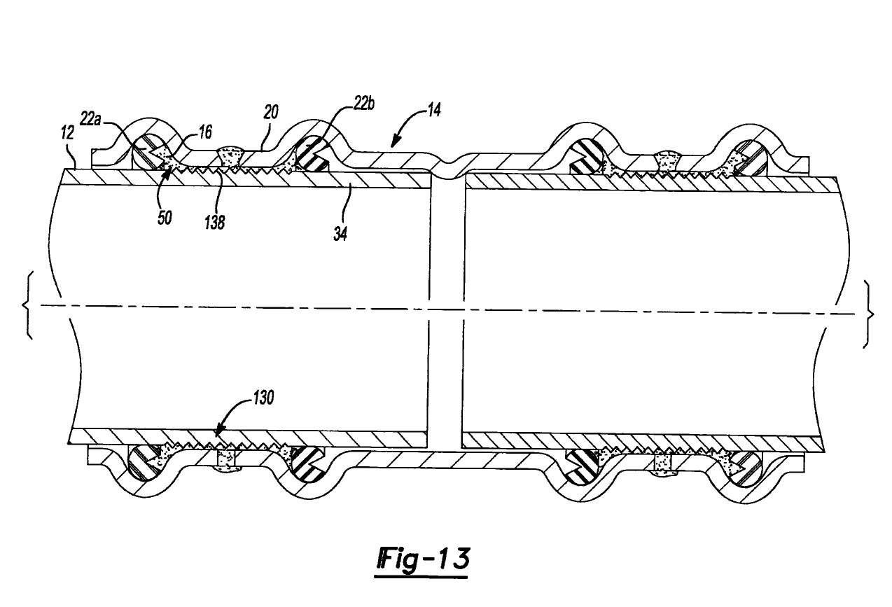

It will be appreciated that the associated end 34 of the structure 12 and/or the body 20 can be configured such that the adhesive 16 does not bond to either the structure 12 or the body 20. In the examples of FIGS. 10 through 13, a locking element 130 can be formed into the associated end 34 of the structure 12 in an area corresponding to the location of the coupling zone 50 (FIG. 13). In FIG. 10, a plurality of dimples 134 are formed about the perimeter of the associated end 34 of the structure 12. The dimples 134 are illustrated to be generally V-shaped in the example provided, but could have any desired shape (e.g., a spherical segment). In the example of FIG. 11, an annular groove 136 is formed about the perimeter of the associated end 34 of the structure 12. In the example of FIGS. 12 and 13, the exterior surface 40 of the associated end 34 of the structure 12 is knurled such that the knurled portion 138 has a diameter that is relatively larger than the diameter of the adjacent sections of the associated end 34 of the structure 12. In any of the examples of FIGS. 10 through 13, the adhesive 16 in the coupling zone 50 need not bond directly to the structure 12 but rather can be received into the dimples 134, the groove 136 and the knurls of the knurled portion 138 such that when the adhesive 16 has cured, the fitting 14 cannot be withdrawn from the structure 12. Accordingly, it will be appreciated that the adhesive 16 need not bond to one or both of the body 20 and the structure 12.

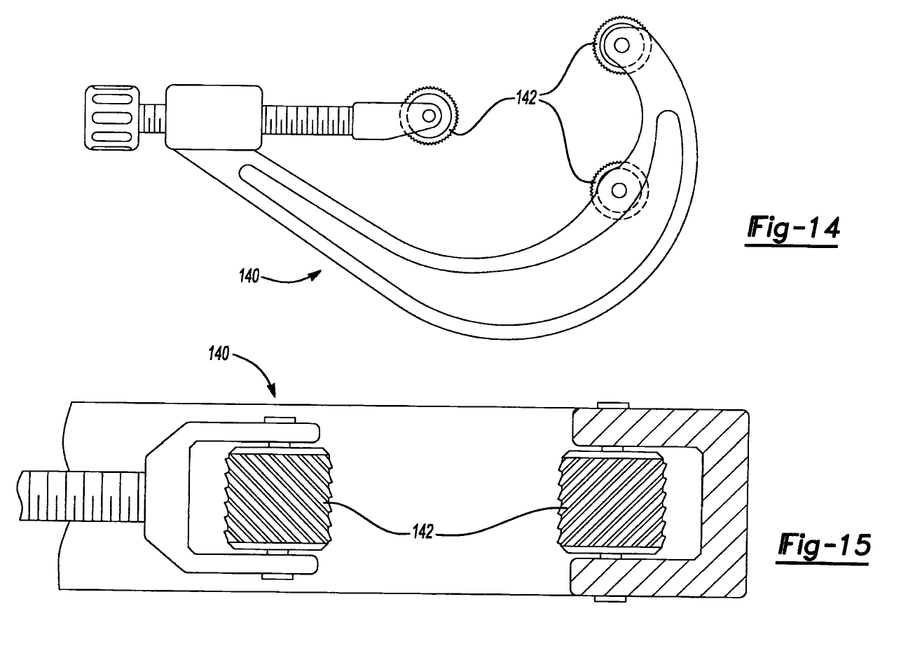

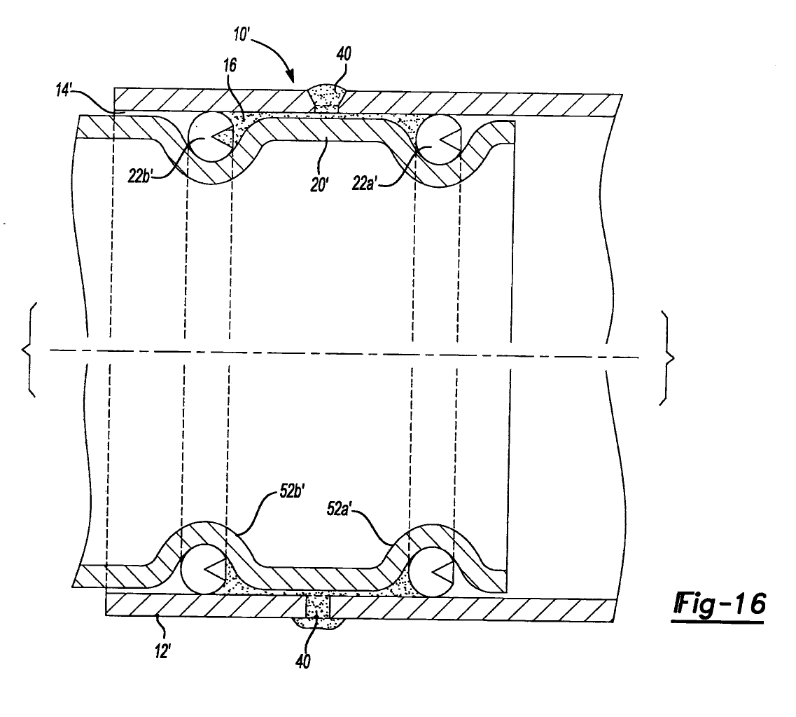

A suitable tool for forming the knurls of the knurled portion 138 is illustrated in FIGS. 14 and 15. The tool 140 can include a plurality of knurling wheels 142 that can be moved relative to one another to drive the knurling wheels 142 into the structure 12 (FIG. 13). Similar tools (not shown) can be employed to form the dimples 134 of FIG. 10 or the groove 136 of FIG. 11. Additionally, powered rotary forming tools for forming locking features, such as grooves, into tubing and piping are commercially available. One such line of tools is known as a Victaulic roll groover, but such tool may require modification to position the groove 136 (FIG. 11) relative to the end face 58 (FIG. 3) of the structure 12 (FIG. 3) in a desired location.

While the assembly 10 (FIG. 1) has been described thus far as including structures 12 (FIG. 3) that are received into a cavity 30 (FIG. 3) in a fitting 14 (FIG. 3), it should be appreciated that in the alternative, the fitting 14′ could be received into the structure 12′ as illustrated in FIG. 16. In this example the apertures 60′ are formed through the structure 12′, the mounts 52a′ and 52b′ are configured to position the sealing elements 22a′ and 22b′ on the exterior of the body 20′ and the adhesive 16 is received between the body 20′ and the structure 12′.

It will be appreciated that the peel strength of the adhesive 16 and the lap shear strength of the joint 18 can be tailored to a desired level through selection of the type of adhesive 16, the length L of the coupling zone 50 and the amount of clearance between the exterior surface 40 of the associated end 34 of the structure 12 and the interior surface 12 of the cavity 30 (hereinafter referred to as “the diametrical clearance”, although those of skill in the art will appreciate that the shapes of the structure 12 and the body 20 need not be circular). Depending on the particular requirements for a given situation, the diametrical clearance and the length L of the coupling zone 50 can be selected so as to increase or decrease the lap shear strength for a given adhesive 16. For example, the length L of the coupling zone 50 can be lengthened or shortened for a given adhesive 16 and a given diametrical clearance to provide more or less surface area over which the adhesive 16 can be disposed. It will be appreciated that lengthening the coupling zone 50 can increase the lap shear strength of the joint 18 to a degree, while shortening the coupling zone 50 can decrease the lap shear strength of the joint 18.

As another example, the diametrical clearance can be increased or reduced to a degree for a given adhesive 16 and length L of the coupling zone 50 to affect not only the lap shear strength of the joint 18, but also the peel strength of the adhesive 16. It will be appreciated that lengthening the coupling zone 50 may not necessarily increase the peel strength of the adhesive 16 in some situations, especially when the diametrical clearance is relatively low, as modest axially directed loads transmitted through the joint 18 can cause the adhesive 16 in the zone 50 to elongate significantly. In this regard, we have noted in our testing that when another adhesive coupling system was employed with relatively large diameter tubes and piping, such as a tube or pipe having a nominal diametrical dimension that is greater than or equal to two inches, the typical diametrical clearance employed in such coupling systems was sufficiently small (e.g., 0.005 inch) so that it was possible for the adhesive to elongate significantly (e.g., greater than 20% in some instances) and peel away from the tubing. In systems with relatively large diameter tubes and/or piping, it is possible to transfer heat to/from the tubing/piping relatively quicker than the body of the fitting and consequently, a relatively temperature difference (e.g., 20° F. or more) between the tubing/piping and the body of the fitting in the relevant area is possible. We note, too, that where different materials are employed for the tubing/piping and the body of the fitting, differences in rates of thermal expansion can further exacerbate this condition.

We have found, too, that it was not possible to modify this other adhesive coupling system to sufficiently enlarge the diametrical clearance as a portion of the tubing/piping in the body of the fitting was unsupported and would adversely affect the connection. In this regard, we noted that diametrical clearances of 0.030 inch permitted sufficient movement of the tubing/piping relative to the body of the fitting so that line-to-line contact between the tubing/piping and the body of the fitting occurred. As a result of such line-to-line contact and the tendency of the adhesive to flow outwardly along the tubing/piping, it was not possible for the adhesive between the tubing/piping and the body of the fitting to consistently achieve a thickness that effectively achieved a desired peel strength. It will be appreciated that control of the diametrical clearance permits the length L of the coupling zone 50 to be minimized (thereby saving material) while maintaining desired peel and lap shear strengths. In this regard the diametrical clearance can be selected such the adhesive in the zone 50 is sufficiently thick at all points around its perimeter so as to limit elongation of the adhesive 16 in the zone 50 to inhibit peel failures of the adhesive 16 in the zone 50 and shear failures of the joint 18 when a temperature differential of at least 25° F. between a temperature of the body 20 at a location adjacent the zone 50 and a temperature of the structure 12 at a location adjacent the zone 50. In such tests on a joint constructed in accordance with the teachings of the present disclosure, four inch nominal diameter tubing and diametrical clearances of 0.030 inch were employed and elongation of the adhesive was reduced to 10% or less (in some instances, elongation was reduced to 6% for a temperature differential of 35° F.).

We have noted that a relatively large diametrical clearance can facilitate the use of different adhesives 16. For example, an adhesive of a first viscosity may be employed if the ambient air temperature is within a first temperature range (e.g., less than 50 degrees F.), while a different adhesive of a second, higher viscosity may be employed if the ambient air temperature is within a second temperature range (e.g., greater than or equal to 50 degrees F.).

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

1. A method for forming a joint comprising:
providing a fitting having a body and a pair of axially spaced apart seals, the body having an insertion end;
providing a structure;
engaging the fitting and the structure to one another such that the seals sealing engage the body and the structure; and
after the fitting and the structure have been engaged to one another, installing an adhesive to a zone disposed between the body, the structure and the seals to retain the body to the structure.

2. The method of claim 1, wherein the adhesive bonds to not more than one of the body and the structure.

3. The method of claim 2, wherein prior to engaging the fitting and the structure to one another the method further comprises forming a locking element on at least one of the body and the structure, the locking element being positioned in the zone and being configured to receive a portion of the adhesive installed to the zone.

4. The method of claim 3, wherein the locking element is selected from a group consisting of dimples, knurls and grooves.

5. The method of claim 1, wherein installing the adhesive includes pumping the adhesive through a fill aperture into the zone.

6. The method of claim 5, wherein installing the adhesive further includes verifying that the adhesive has exited a vent aperture.

7. The method of claim 5, wherein installing the adhesive further includes metering a predetermined volume of the adhesive into the zone.

8. The method of claim 1, wherein the structure is received into a cavity in the insertion end and the seals sealingly engage an exterior surface of the structure.

9. The method of claim 1, wherein the structure defines an internal aperture, wherein the fitting is received into the internal aperture and wherein the seals sealingly engage an interior surface of the structure.

10. The method of claim 1, wherein a dimension of the zone between the body and the structure is sufficiently thick at all points around a perimeter of the zone so as to limit elongation of the adhesive in the zone to inhibit peel and shear failures of the adhesive in the zone when a temperature differential of at least 25° F. between a temperature of the body at a location adjacent the zone and a temperature of the structure at a location adjacent the zone.

11. The method of claim 1, wherein the structure is disposed in a generally vertical orientation and wherein dry friction between the seals and the structure are sufficient to retain the fitting and the structure to one another while the adhesive in the zone cures.

12. The method of claim 11, wherein the structure is hollow and has a nominal diametrical dimension that is greater than two inches.

13. The method of claim 1, wherein prior to installing the adhesive the method further comprises selecting the adhesive from a group of adhesives having different viscosities, the selection being at least partly based on an ambient air temperature.

14. The method of claim 1, wherein the structure is formed of a first material and the body is formed of a second material that is different from the first material.

15. A method for forming a joint comprising:
providing a fitting having a body and a pair of axially spaced apart seals, the body having an insertion end;
engaging the fitting and a structure to one another such that the seals sealing engage the body and the structure;
after the fitting and the structure have been engaged to one another, pumping an adhesive to a zone disposed between the body, the structure and the seals while simultaneously venting the zone of air; and
curing the adhesive in the zone to retain the body to the structure.

16. The method of claim 15, wherein a dimension of the zone between the body and the structure is sufficiently thick at all points around a perimeter of the zone so as to limit elongation of the adhesive in the zone to inhibit peel and shear failures of the adhesive in the zone when a temperature differential of at least 25° F. between a temperature of the body at a location adjacent the zone and a temperature of the structure at a location adjacent the zone.

17. The method of claim 1, wherein the structure is disposed in a generally vertical orientation and wherein dry friction between the seals and the structure are sufficient to retain the fitting and the structure to one another while the adhesive in the zone cures.

18. The method of claim 17, wherein the structure is hollow and has a nominal diametrical dimension that is greater than two inches.

19. The method of claim 15, wherein prior to engaging the fitting and the structure to one another the method further comprises forming a locking element on at least one of the body and the structure, the locking element being positioned in the zone and being configured to receive a portion of the adhesive installed to the zone.

20. The method of claim 19, wherein the adhesive bonds to not more than one of the body and the structure.

21. The method of claim 15, wherein the adhesive is pumped into the zone via a first aperture and air is vented from the zone via a second aperture.

22. A fitting comprising:
a body having an insertion end with an end face, the body defining a cavity with a first mount, a second mount, a fill aperture and a vent aperture, the second mount being spaced axially apart from the first mount;
a first seal received in the first mount; and
a second seal received in the second mount;
wherein the fill aperture and the vent aperture extend radially through the body and wherein the fill aperture and the vent aperture are disposed between the first and second seals.

23. The fitting of claim 22, wherein at least one of the first and second seals is a lip seal.

24. The fitting of claim 22, wherein the first mount and the first seal cooperate to form a first annular channel and wherein the second mount and the second seal cooperate to form a second annular channel.

25. The method of claim 4, wherein the adhesive does not bond to either of the body and the structure.

26. The method of claim 20, wherein the adhesive does not bond to either of the body and the structure.
